(19) United States
(12) Patent Application Publication
(10) Pub. No.: US 2017/0090133 A1
(43) Pub. Date: Mar. 30, 2017

(54) HOUSING AND OPTICAL TRANSCEIVER MODULE

(71) Applicant: NEC Corporation, Tokyo (JP)

(72) Inventor: Atsushi KOZATO, Tokyo (JP)

(73) Assignee: NEC Corporation, Tokyo (JP)

(21) Appl. No.: 15/126,476

(22) PCT Filed: Feb. 27, 2015
(86) PCT No.: PCT/JP2015/001039

§ 371 Date: Sep. 15, 2016

(30) Foreign Application Priority Data
Mar. 26, 2014 (JP) 2014-062863

(51) Int. Cl. G02B 6/42; G02B 6/38

(52) U.S. Cl. CPC G02B 6/4277; G02B 6/428; G02B 6/3897

(57) ABSTRACT

This invention provides an inexpensive housing that can prevent electromagnetic radiation even when a connecting member is inserted into said housing. Said housing is characterized by comprising the following: a box-shaped shield inside which an electronic device that emits electromagnetic radiation is placed; an opening, formed in said shield, into which a connecting member is inserted; and a radio-wave-absorbing sheet that covers said opening. This housing is also characterized in that a cutout is formed in the radio-wave-absorbing sheet and the region of the radio-wave-absorbing sheet that faces the connecting member gets folded towards the inside of the housing when the connecting member is pressed up against the cutout.

### TECHNICAL FIELD

The present invention relates to a housing and an optical transceiver module, and particularly relates to a housing and an optical transceiver module which cut off electromagnetic radiation noise.

### BACKGROUND ART

In communication devices like an optical transceiver module using an optical fiber, such as Gigabit Ethernet (Registered Trademark) and a fiber channel, unnecessary radiation of electromagnetic waves becomes a big problem. Technologies suppressing the unnecessary radiation of electromagnetic waves are disclosed, for example, in Patent Literatures 1 to 3.

An optical transceiver module in which influence of electromagnetic radiation is reduced is disclosed, for example, in Patent Literature 4. A front view of the optical transceiver module of Patent Literature 4 is illustrated in the left side of FIG. 1, and a drawing of internal structure seen from a side is illustrated in the right side of FIG. 1. As shown in FIG. 1, a light source module, a reception module, and an external modulator which transmits/receives signals to/from these modules are disposed in a housing 101. An optical fiber is inserted from the outside into the inside of the housing 101 through a hole 102 for optical fiber extraction which is formed in the housing 101 to be connected to the external modulator in the housing 101. An optical transceiver module of Patent Literature 1 has only one hole 102 for optical fiber extraction, thereby reduces influence of electromagnetic radiation.

### CITATION LIST

### Patent Literature

[PTL1] Japanese Laid-Open Patent No. 2004-128248

[PTL2] Japanese Laid-Open Patent No. Hei 1-256198

[PTL3] Japanese Laid-Open Patent No. Hei 1-248699

[PTL4] Japanese Laid-Open Patent No. 2008-111989

### SUMMARY OF INVENTION

### Technical Problem

For example, a receptacle, which is used when data for manufacturing, adjustment or the like is written in a memory formed in an internal printed board, is disposed on the internal printed board disposed inside a light source module. When it becomes necessary to write data in the memory in the light source module after operation of an optical transceiver module starts, a connector plug is inserted into the housing 101 to be connected to the receptacle, and the data is written into the memory through the connector plug.

Insertion of the connector plug is usually performed through an opening only for the connector plug which is different from a hole 102 for optical fiber extraction formed in the housing 101. As described above, since it is needed such a structure in which a gap is not generated at the opening in order to prevent electromagnetic radiation, it is necessary to match the shape of the opening and the shape of the connector plug.

However, in case when writing to the memory is performed several times per year, it is costly and useless to design specific connector plug and specific opening.

The present invention is made in consideration of the above-mentioned problem, and an object of the invention is to provide a low-cost housing and an optical transceiver module using the housing which can prevent electromagnetic radiation when a connecting member is inserted into the housing.

### Solution to Problem

A housing structure according to the present invention, including: a box-shaped shield inside which an electronic device that emits electromagnetic radiation is to be disposed; an opening, formed in the shield, into which a connecting member is to be inserted; and a radio-wave-absorbing sheet, in which a slit is formed, that covers the opening, and characterized in that a region of the radio-wave-absorbing sheet that faces the connecting member gets folded towards the inside of the housing when the connecting member is pressed up against the slit.

An optical transceiver module according to the present invention, including: the housing; an internal printed board that is disposed inside the housing; and an electronic device emitting electromagnetic radiation that is disposed inside the housing.

### Advantageous Effect of Invention

According to the invention, it enables to provide the low-cost housing and the optical transceiver module using the housing which can prevent electromagnetic radiation when the connecting member is inserted into the housing.

### BRIEF DESCRIPTION OF DRAWINGS

FIG. 1 is a front view and an internal structure diagram of an optical transceiver module of Patent Literature 4.

FIG. 2 is a perspective view of a housing illustrating a first exemplary embodiment.

FIG. 3 is a diagram illustrating a part of the housing of the first exemplary embodiment.

FIG. 4 is a diagram explaining a method of electrical connection in the first exemplary embodiment.

FIG. 5 is a diagram illustrating a part of a housing a second exemplary embodiment.

### DESCRIPTION OF EMBODIMENTS

By referring to the drawings, exemplary embodiments of the present invention are explained in detail. In the following exemplary embodiments, technically preferable limitations for working of the invention are described. However the limitations do not limit the scope of the invention to the following.

### First Exemplary Embodiment

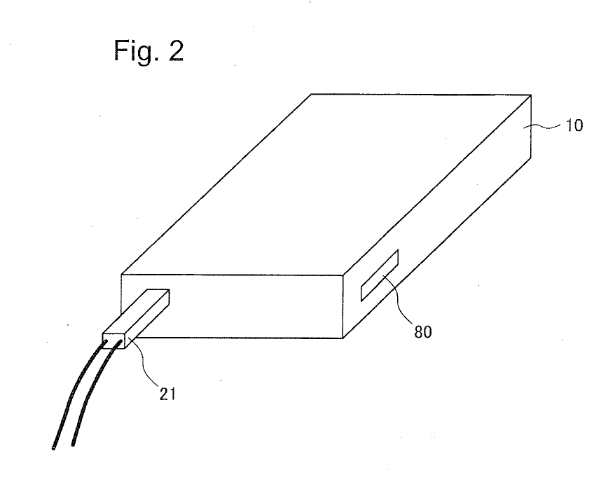

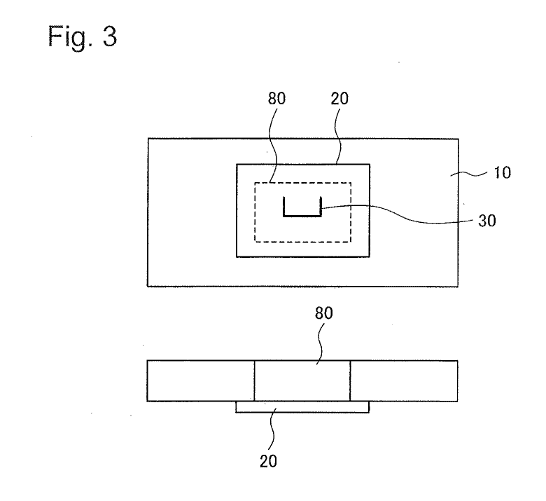

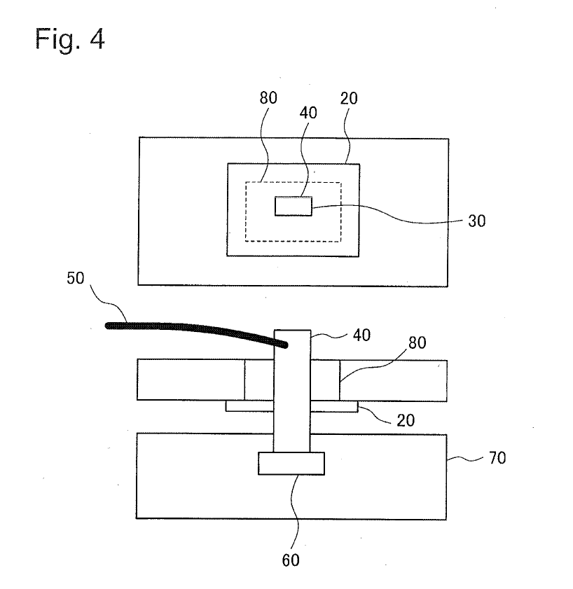

A housing of a first exemplary embodiment of the present invention is explained. FIG. 2 illustrates a perspective view of a housing 10 of the exemplary embodiment. FIG. 3 illustrates a front view and a top view of a surrounding area of an opening 80 which is formed on a side face of the housing 10. FIG. 4 illustrates a front view and top view of the surrounding area of the opening 80 of the housing 10 of the exemplary embodiment into which a printed board 40 for connector is inserted.

The housing 10 shown in FIG. 2 is formed to be box-shaped, and is configured by an aluminum case which performs electromagnetic shielding. The opening 80 for writing and an optical fiber entrance/exit hole 21 are provided with the aluminum case forming the housing 10. An electronic device which emits electromagnetic radiation (not shown), a connector 60 for data writing (FIG. 4), and an internal printed board 70 (FIG. 4) exist inside the housing 10. The connector 60 and the internal printed board 70 are not exposed to the outside.

The opening 80 is provided with a side face of the housing 10. The opening 80 is formed near the internal printed board 70 which is a writing target. As shown in FIG. 3, a radio-wave-absorbing sheet 20 for covering the opening 80 is stuck on an inside face of the housing 10 by using adhesive or the like. The radio-wave-absorbing sheet 20 may be stuck on an outside face of the housing 10.

The radio-wave-absorbing sheet 20 is made of flexible material such as rubber, or the like. A radio-wave-absorbing sheet on the market which is generally used may be used.

A slit 30 which has a shape corresponding to a shape of a printed board 40 for connector is formed in the radio-wave-absorbing sheet 20. In the exemplary embodiment, corresponding to the printed board 40 for connector having a rectangle shape, a slit is formed at a location on the radio-wave-absorbing sheet 20 corresponding to that of three sides in the four sides of the rectangle to form the slit 30. Therefore, slits of two sides facing each other in the slit 30 formed from the three sides (hereinafter, referred to as vertical slit) is nearly equal to the height of the printed board 40 for connector, and a slit of the other one side (hereinafter, referred to as horizontal slit) is nearly equal to the width of the printed board 40 for connector.

The slit 30 mentioned above is normally closed. When the radio-wave-absorbing sheet 20 in which the slit 30 is formed covers the opening 80, electromagnetic radiation from the opening 80 is prevented.

When the printed board 40 for connector is inserted, by pressing up the printed board 40 for connector against the slit 30 which is formed in the radio-wave-absorbing sheet 20, a region of the radio-wave-absorbing sheet 20 which faces the printed board 40 for connector gets folded towards the inside of the housing 10 and the printed board 40 for connector is inserted into the housing 10. At this time, since the shape of the slit 30 corresponds to the shape of the printed board 40 for connector, no gap is generated between the printed board 40 for connector and the radio-wave-absorbing sheet 20 (the slit 30). Therefore, electromagnetic radiation can be continuously prevented even when the printed board 40 for connector is inserted into the housing 10.

An optical transceiver module using the housing 10 above described is explained. By using FIG. 4, a method for electrically connecting the printed board 40 for connector to the internal printed board 70 which is disposed in the optical transceiver module is explained.

The internal printed board 70 on which a circuit which is a target for data writing (e.g. memory) is disposed is disposed inside the optical transceiver module. The connector 60 which is connected to the printed board 40 for connector which is inserted from the outside is disposed on the internal printed board 70. The connector 60 is, for example, a card-edge type, and a general-purpose component like for SFP (Small Form Factor Pluggable) optical transceiver and AKX-20LFY (made by Honda Tsushin Kogyo Co., Ltd) can be used.

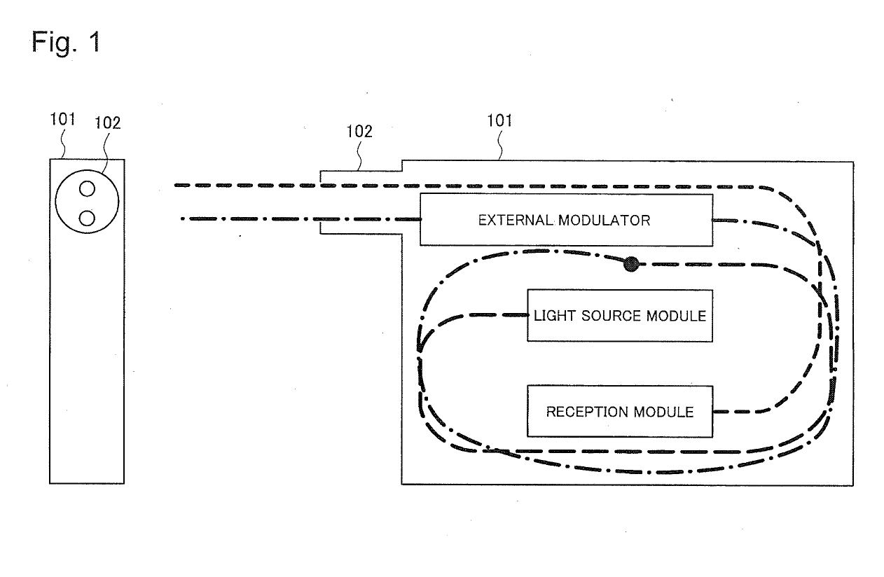

In the printed board 40 for connector which is inserted from the outside, a general-purpose printed board designed based on SFP (SFF-8084 FIG. 6-1) can be used. A writing cable 50 for supply of writing data is connected to the printed board 40 for connector.

When writing to memory which is mounted on the internal printed board 70 which is disposed inside the optical transceiver module is performed by using the printed board 40 for connector, it is done as follows. In the optical transceiver module, the printed board 40 for connector is pressed up against the slit 30 formed in the radio-wave-absorbing sheet 20 which covers the opening 80 of the housing 10. Thereby the region of the radio-wave-absorbing sheet 20 which faces the printed board 40 for connector gets folded towards the inside of the housing 10, and the printed board 40 for connector is inserted into the housing 10. In the housing 10, the printed board 40 for connector is connected to the connector 60 disposed on the internal printed board 70. Thereby the printed board 40 for connector is electrically connected to the internal printed board 70. In this state, by supplying writing data from the writing cable 50 connected to the printed board 40 for connector, data for manufacturing, adjustment, or the like is written into the memory mounted on the internal printed board 70.

Since the shape of the slit 30 corresponds to the shape of the printed board 40 for connector, gap will not be generated between the printed board 40 for connector and the radio-wave-absorbing sheet 20 (slit 30) even if the printed board 40 for connector is inserted into the optical transceiver module. Therefore, electromagnetic radiation is prevented. Further cost increase is suppressed, since a specific connector plug or the like is not required.

### Second Exemplary Embodiment

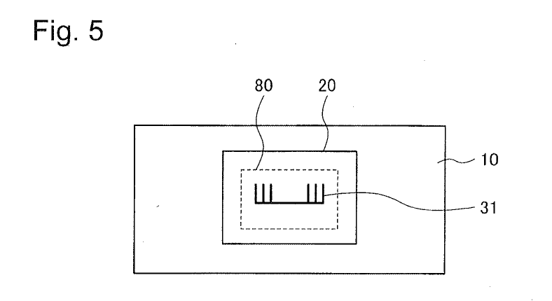

A second exemplary embodiment is explained. FIG. 5 illustrates a front view around the opening 80 which is formed on the side face of the housing 10 in the exemplary embodiment. As shown in FIG. 5, this exemplary embodiment differs from the first exemplary embodiment in the shape of the slit formed in the radio-wave-absorbing sheet 20. A slit 31 of FIG. 5 is formed by further adding two sets of vertical slits to the slit 30 corresponding to the three sides of the rectangle described in the first exemplary embodiment. Due to the shape, it becomes possible to match a plurality of kinds of printed boards for connector which are different in width. Since parts except the slit shape of this exemplary embodiment are the same as those of the first exemplary embodiment, explanations thereon are omitted.

The invention of the present application is not limited to the above mentioned exemplary embodiments. Various design changes can be made within a range not departing from the scope of the invention. A part or all of the exemplary embodiments may be described as following supplementary notes, however is not limited to the following.

### [Supplementary Note 1]

A housing structure including; a housing having an electronic device for emitting electromagnetic radiation and an internal printed board which is a connector for writing data to the electronic device therein; an opening formed in the housing; and a radio-wave-absorbing sheet configured to cover the opening, and characterized in that a slit whose shape corresponds to a shape of an external printed board for connector which connects to the internal printed board is formed in the radio-wave-absorbing sheet.

### [Supplementary Note 2]

The housing structure of the supplementary note 1, characterized by including an end slit which is formed at both ends of the slit almost vertically with respect to the slit.

### [Supplementary Note 3]

The housing structure of the supplementary note 2, characterized in that a plurality of the end slits are formed near the both ends of the slit.

### [Supplementary Note 4]

The housing structure of the supplementary note 1, characterized in that the length of the slit is nearly equal to the width of the external printed board for connector.

### [Supplementary Note 5]

The housing structure of the supplementary note 2, characterized in that the length of the slit is nearly equal to the thickness of the external printed board for connector.

### [Supplementary Note 6]

The housing structure of the supplementary note 1, wherein the housing is a housing of an optical transceiver module.

### [Supplementary Note 7]

The housing structure of the supplementary note 6, characterized in that the internal printed board is a printed substrate for SFP optical transceiver, and the external printed board for connector is a printed substrate based on SFP.

### [Supplementary Note 8]

A method of electrical connection with an electronic device, the method of electronic connection with a housing including a housing having an electronic device that emits electromagnetic radiation and an internal printed board which is a connector for writing data to the electronic device therein, an opening formed in the housing, and a radio-wave-absorbing sheet configured to cover the opening, wherein a slit whose shape corresponds to a shape of an external printed board for connector which connects to the internal printed board is formed in the radio-wave-absorbing sheet, including:
inserting the external printed for connector into the slit part which is normally closed to connect to the internal printed board; and
writing data after that.

### INDUSTRIAL APPLICABILITY

The invention can be widely applied to a housing in which an electronic device emitting electromagnetic radiation is disposed.

This application is based upon and claims the benefit of priority from Japanese patent application No. 2014-062863, filed on Mar. 26, 2014, the disclosure of which is incorporated herein in its entirety by reference.

### REFERENCE SIGNS LIST

10 Housing

20 Radio-wave-absorbing sheet

30, 31 Slit

40 Printed board for connector

50 Writing cable

60 Connector

70 Internal printed board

80 Opening

1. A housing comprising:
a box-shaped shield member inside which an electronic device that emits electromagnetic radiation is disposed;
an opening, formed in the shield member, into which a connecting member is to be inserted; and
a radio-wave-absorbing sheet, in which a slit is formed, that covers the opening,
wherein a region of the radio-wave-absorbing sheet that faces the connecting member gets folded towards the inside of the housing when the connecting member is pressed up against the slit.

2. The housing according to claim 1, wherein the radio-wave-absorbing sheet is made of a resilient member.

3. The housing according to claim 1, wherein the radio-wave-absorbing sheet is stuck on an internal face of the shield member.

4. The housing according to claim 1, wherein when an external shape of the connecting member is a rectangle shape, the slit has a shape which is formed from three sides of the rectangle.

5. The housing according to claim 4, wherein, in the slit, a slit piece is further formed between slit pieces corresponding to two sides of the three sides facing each other, the slit piece having a shape equal to that of the slit pieces corresponding to the two sides facing each other.

6. An optical transceiver module, comprising:
the housing according to claim 1;
an internal printed board that is disposed inside the housing; and
an electronic device emitting electromagnetic radiation that is disposed inside the housing.

7. The optical transceiver module according to claim 6, wherein the internal printed board is a printed substrate for SFP optical transceiver, and the connecting member is a printed substrate based on SFP, the member being connected to the internal printed board.
